(19) United States
(12) Patent Application Publication
(10) Pub. No.: US 2008/0034294 A1
(43) Pub. Date: Feb. 7, 2008

(54) Tactile presentation of properties of a resource referenced through a link

(75) Inventors: Sami Ronkainen, Oulu (FI); Topi Kaaresoja, Tuusula (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 11/490,649

(22) Filed: Jul. 21, 2006

(51) Int. Cl. G06F 3/01; G06F 17/00; G06F 3/048

(52) U.S. Cl. 715/702; 715/205; 715/207; 715/767; 715/822

(57) ABSTRACT

A method includes determining, in response to focus being set on a link referencing a resource, one or more properties of the resource referenced by the link. Data is selected corresponding to one or more of a plurality of tactile feedback patterns based on the properties. Tactile feedback is enabled corresponding to the one or more tactile feedback patterns based at least in part on the data. An electronic device includes memories having a set of instructions and processors coupled to the memories. The processors are configured by the instructions to determine, in response to focus being set on a link referencing a resource, properties of the resource referenced by the link, to select data corresponding to one or more tactile feedback patterns based on the properties, and to enable tactile feedback corresponding to the one or more tactile feedback patterns.

### TECHNICAL FIELD

This invention relates generally to computer systems and, more specifically, relates to links on a screen of computer systems.

### BACKGROUND

For a variety of reasons, the Internet has become an important aspect of the lives of many people. One part of the Internet is the World Wide Web (WWW), a collection of interconnected computers, some of which have websites located at particular internet addresses. The WWW is typically called “the web”. Many Internet addresses are accessed using a protocol called hypertext transport protocol (HTTP).

One way to traverse the WWW is to use a “web browser”, which is a program that can access websites using corresponding Internet addresses. Websites are typically coded using hypertext markup language (HTML). Each website usually includes one or more “pages”, interconnected through links. The links are presented by the web browser to a user. A link typically includes a title that is shown to a user and a reference to a resource, where the reference is hidden from the user. In terms of a link to a page, the reference includes an HTTP address. The page could be within or outside of the website.

Although pages written in HTML include the majority of internet resources accessible by links, other internet resources may also be referenced by links. For instance, links can reference files using file transport protocol (FTP) information. Furthermore, links can reference other internet resources such as really simple syndication (RSS), radio station streams, portable document format (PDF) documents, spread sheet documents, and word processor documents.

Because the Internet is so popular, many mobile electronic devices such as cellular phones and personal digital assistants (PDAs) now have Internet access capability and in particular web browsers. While such devices enable the Internet to be accessed at many locations, these devices have small screens, which limits the amount of information that can be shown to a user.

While web browsing in general and in particular on mobile electronic devices is popular and provides many benefits, access to internet resources could be improved from the standpoint of a user.

### BRIEF SUMMARY

In an exemplary embodiment of the invention, a method includes determining, in response to focus being set on a link referencing a resource, one or more properties of the resource referenced by the link. The method also includes selecting data corresponding to one or more of a plurality of tactile feedback patterns based on the one or more properties. The method further includes enabling tactile feedback corresponding to the one or more tactile feedback patterns based at least in part on the data.

In another exemplary embodiment of the invention, an electronic device is disclosed that includes one or more memories comprising a set of instructions. The electronic device also includes one or more processors coupled to the one or more memories. The one or more processors execute the set of instructions. The one or more processors are configured by the set of instructions to determine, in response to focus being set on a link referencing a resource, one or more properties of the resource referenced by the link. The one or more processors are also configured to select data corresponding to one or more of a plurality of tactile feedback patterns based on the one or more properties, and to enable tactile feedback corresponding to the one or more tactile feedback patterns based at least in part on the data.

In another exemplary embodiment, a signal bearing medium is disclosed that tangibly embodies a program of machine-readable instructions executable by a processor to perform operations. The operations include determining, in response to focus being set on a link referencing a resource, one or more properties of the resource referenced by the link. The operations also include selecting data corresponding to one or more of a plurality of tactile feedback patterns based on the one or more properties. The operations further include enabling tactile feedback corresponding to the one or more tactile feedback patterns based at least in part on the data.

### BRIEF DESCRIPTION OF THE DRAWINGS

The foregoing and other aspects of embodiments of this invention are made more evident in the following Detailed Description of Exemplary Embodiments, when read in conjunction with the attached Drawing Figures, wherein:

FIG. 1 is a block diagram of a system that provides access to a number of resources and provides tactile presentation of properties of resources referenced through links;

FIG. 2 is a block diagram of an electronic device suitable for tactile presentation of properties of resources referenced through links;

FIGS. 3 and 4 are examples of possible electronic devices of FIG. 2;

FIG. 5 is a graph of a number of exemplary tactile feedback patterns;

FIG. 6 is a block diagram of data corresponding to a “not found” tactile feedback pattern;

FIG. 7 is a flowchart of a method for tactile presentation of properties of resources referenced through links;

FIG. 8 is a graph of two appended tactile feedback patterns;

FIG. 9 is a diagram of events for a gesture when a user interacts with a touch screen and of software interactions in response to events in the diagram;

FIGS. 10-14 are examples of events of FIG. 9 for gestures using a touch screen; and

FIG. 15 is a block diagram of possible hardware element(s) used to implement tactile presentation logic.

### DETAILED DESCRIPTION OF EXEMPLARY EMBODIMENTS

As described above, the Internet has become an important aspect of the lives of many people. When using a web browser, it would often be valuable to know if a link is dead or up to date. Especially when using a mobile electronic device, information about the size of the file behind the link and, if available, a speed of the connection to the computer behind the link would be valuable information. However, in a mobile electronic device such as a cellular phone, there is often little space available for visually presenting this kind of information. Furthermore, in a mobile usage context, the eyes of the user may be occupied. And even if the user can look at the display, the mobile usage context may require the attention of the user to a certain extent, so providing extra information would be beneficial.

Furthermore, in mobile electronic devices, often a tactile feedback channel is provided, typically implemented with a tactile feedback device such as a vibra motor or a piezoelectric actuator. Usually such tactile feedback channels are used for notification of alarms such as an alarm for an incoming telephone call. However, the inventors have realized that this tactile feedback channel can be used to provide information in a web browser about whether it pays off to select a link or not. More generally, the inventors have realized that it would be beneficial for users to be presented with tactile feedback when using a web browser that references resources using links. Although aspects of the disclosed invention have benefit on mobile electronic devices, the disclosed invention is not limited to mobile electronic devices as described in more detail below.

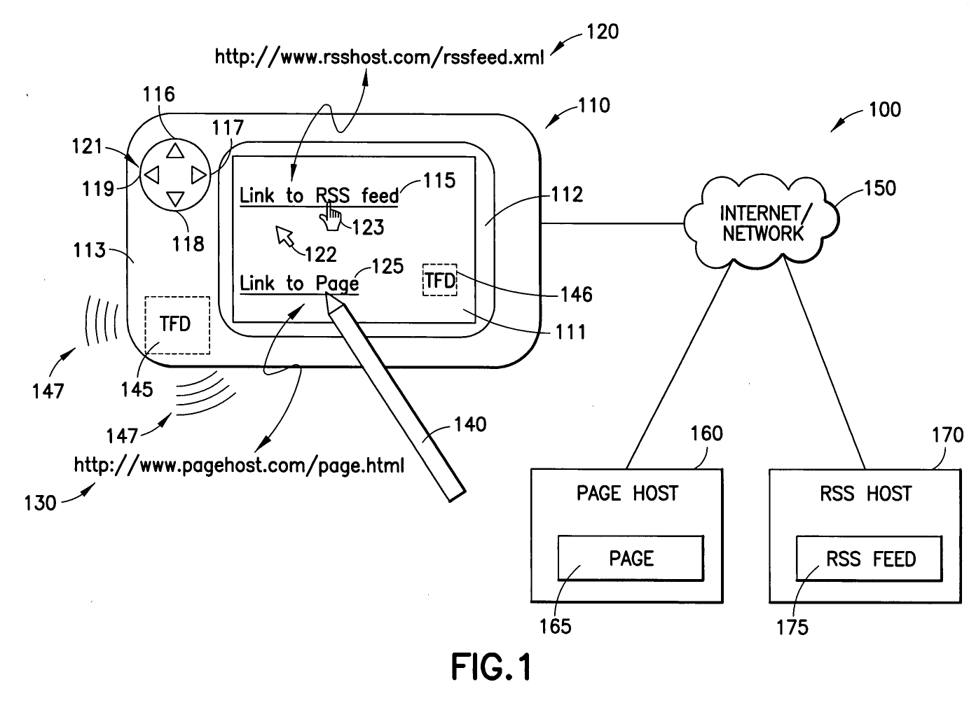

Turning to FIG. 1, a block diagram is shown of a system 100 that provides access to a number of resources and provides tactile presentation of properties of resources referenced through links. System 100 comprises an internet tablet 110, a page host 160, and a really simple syndication (RSS) host 170 coupled to the Internet 150. It is noted that the Internet 150 may also be a network, such as a wide area network (WAN) utilized by an organization. A web page 111 is being displayed on the touch screen 112 of the internet tablet 110. The web page 111 includes two links 115 and 125. The link 115 is a link to an RSS feed 175 on RSS host 170. The link 125 is a link to web page 165 of page host 160. The link 125 is a hyperlink, which is an element in an electronic document that links to an entirely different electronic document. Link 115 references the RSS feed 175 by using the reference of the HTTP address 120, which is an extensible markup language (XML) address. Similarly, the link 125 references the web page 165 by using the reference of the HTTP address 130.

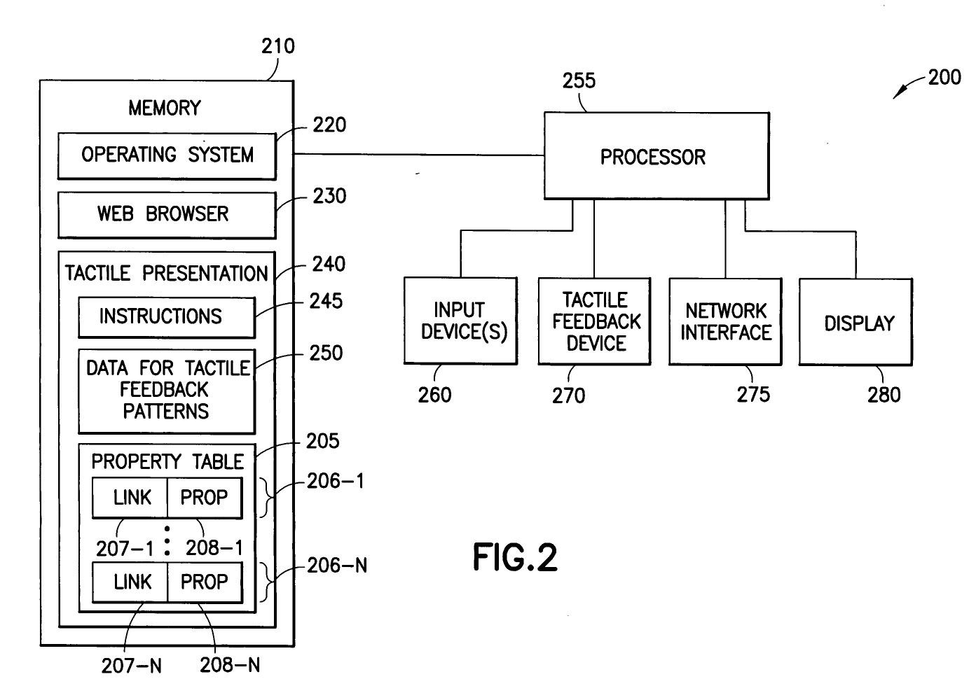

The internet tablet 110 includes a tactile feedback device (TFD) 145. The tactile feedback device 145 is coupled to the body 113 of the internet tablet 110. The tactile feedback device 145 produces a tactile feedback, in this example a vibration 147, when directed by a tactile presentation program (not shown in FIG. 1 but shown in FIG. 2). When a user uses the an input device to set a focus on a link 115, 125, the tactile presentation program determines one or more properties of the resource and produces a tactile feedback pattern (see FIG. 5) using the tactile feedback device 145. In the example of FIG. 1, a stylus 140 is used to set focus on link 125. If the web page 165 referenced by the link 125 is not found, the tactile presentation program can cause a particular tactile feedback pattern (e.g., a “not found” tactile feedback pattern) to be presented to the user using the tactile feedback device 145. As another example, if the web page 165 referenced by the link 125 is found and is a “small” file, the tactile presentation program can cause another tactile feedback pattern (e.g., a “small file” tactile feedback pattern) to be presented to the user using the tactile feedback device 145. As yet another example, if the RSS feed 175 has not been updated within some predetermined time, the tactile presentation program can cause yet another tactile feedback pattern (e.g., a “not up to date” tactile feedback pattern) to be presented to the user using the tactile feedback device 145.

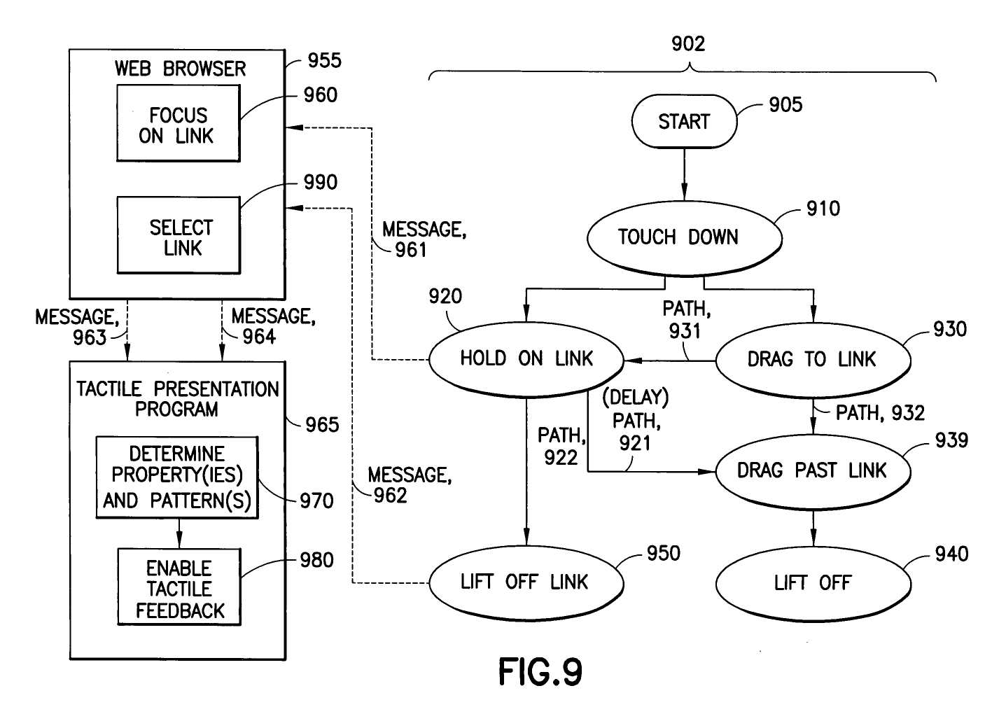

Thus, the internet tablet 110, through use of a tactile presentation program, provides the user with the ability to determine properties of the resource (e.g., web page 165, or RSS feed 175) referenced by the links 115, 125. Should the user decide to follow the link 115, 125 based on the tactile feedback, the user can select the link 115, 125. Selecting the link 115, 125 can be performed through a number of techniques, such as hitting a button (e.g., button 121), clicking a mouse button (not shown in FIG. 1), or removing the stylus 140 from the touch screen 112. Briefly, setting a focus on a link 115, 125 by using a stylus 140 is performed by placing the stylus 140 on the surface 114 of the touch screen 112 and maneuvering the stylus 140 over (e.g., within some predetermined distance of) the link 115, 125. More information on touch screens and user interaction therewith is given below in relation to FIG. 9. In the example of FIG. 1, the stylus 140 and touch screen 112 provide one way of inputting information into the internet tablet 110.

Although resources are shown in FIG. 1 as being a web page 165 and an RSS feed 175, other resources such as but not limited to portable document format (PDF) files, word processing files, spreadsheet files, image files, video files, song files, radio station streams, and file transport protocol (FTP) files are also possible. Furthermore, the resources need not be placed on or accessible through the Internet and could be, e.g., stored in a local area network, in a cache, or on the internet tablet 110 itself. Any resource able to be referenced by a link may be used herein. It is noted that not all of the properties of a web page are necessarily applicable to other resources. For example, a radio station stream will typically have a bit rate and generally will not be “revised” to be “up to date”. Nonetheless, embodiments of the disclosed invention may be useful for indicating through tactile feedback the bit rate or whether the radio station is online.

FIG. 1 also shows the internet tablet 110 having a button 121 that has four portions 116, 117, 118, and 119. Each portion 116-119 allows a user to move a cursor 122 to the top (116), right (117), bottom (118), and left (119). When the cursor 122 is moved to a position to set focus on a link (e.g., link 115 as shown in FIG. 1), the cursor 122 might change into hand cursor 123 to indicate that the user has set focus on the link 115. Pushing the button 121 when the focus is set on the link 115 will cause the resource referenced by the link 115 to be accessed. It should be noted that the focus could also be indicated as being set on a link 115, 125 by, e.g., highlighting the link 115, 125.

Furthermore, some touch screens 112 allow force feedback. For example, some touch screens 112 will provide force feedback to “push” back at the stylus 140. For instance, Popyrev and Maruyama, “Tactile interfaces for small touch screens”, ACM, UIST (2003) describes a touch screen where “TouchEngine” actuators 146 are embedded inside the touch screen itself. The actuators 146 then provide tactile feedback directly to the stylus 140 through the touch screen 112.

It is also noted that the tactile feedback device 145 is not necessarily placed in a realistic position but is shown for expository purposes only. In most portable electronic devices, a tactile feedback device 145 is placed in a location to maximize vibration, and this location will depend on the electronic device.

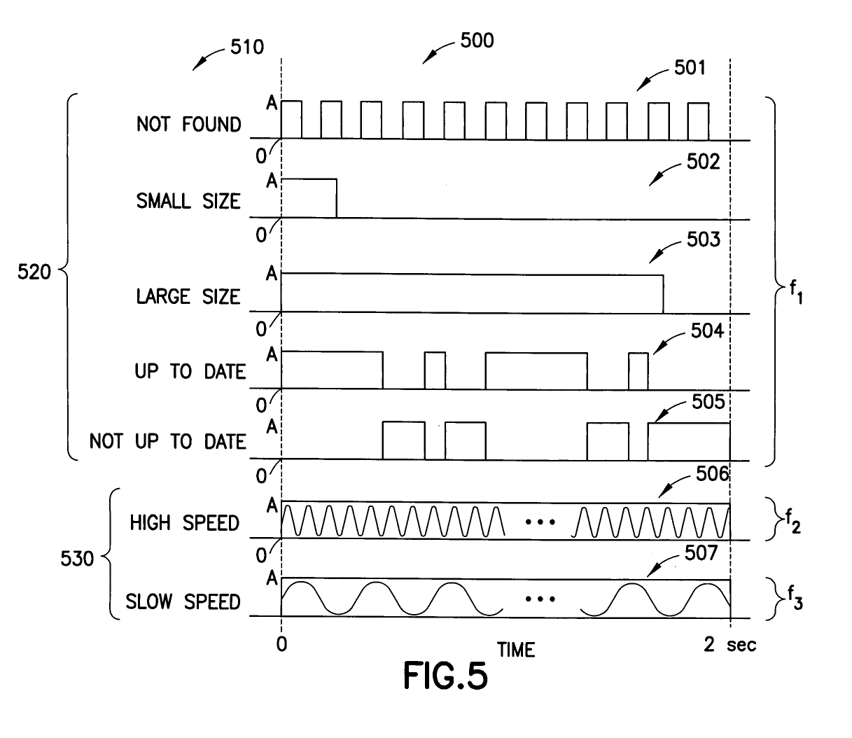

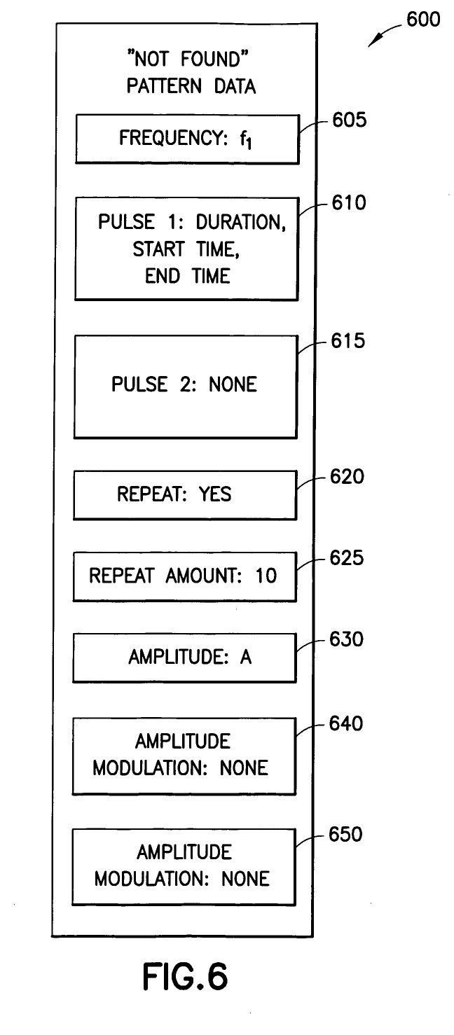

Referring now to FIG. 2, a block diagram is shown of an electronic device 200 suitable for tactile presentation of properties of resources referenced through links. One example of an electronic device 200 has already been shown as internet tablet 110. The electronic device 200 includes a memory 210, one or more input devices 260, one or more tactile feedback devices 270, one or more network interfaces 275, and one or more displays 280 that are all coupled to a processor 255. The memory 210 includes an operating system 220, a web browser 230, a tactile presentation program 240, and a property table 205. Property table 205 includes N entries 206-1 through 206-N, each entry having a link portion 207 and a property portion 208. The tactile presentation program 240 includes a number of instructions 245 suitable for execution on the processor 255 and suitable for causing the processor 255 to carry out one or more operations described herein for tactile presentation of properties of resources referenced through links. The data 250 corresponds to a number of tactile feedback patterns. Exemplary tactile feedback patterns are shown in FIG. 5 and exemplary data corresponding to one of the tactile feedback patterns are shown in FIG. 6.

The tactile presentation program 240 is shown being separate from the web browser 230. However, such separation is for ease of exposition and the tactile presentation program 240 can be integrated (e.g., as a “plug in”) into the web browser 230 if desired. Similarly, the web browser 230 could be integrated into the operating system 220, as could the tactile presentation program 240. It should be noted that each of the processor 255 and memory 210 can be distributed or singular. A distributed process for example includes multiple interconnected processors. Memory 210 will typically include a combination of read-only memory (ROM) and read-write memory. Such memory 210 may include short-term and long-term memory (e.g., a hard drive, compact disk, digital versatile disk, or flash memory). As such, an embodiment herein includes a signal bearing medium (e.g., as part of memory 210) embodying a program of machine-readable instructions executable by processor 255 to perform operations described herein. The one or more network interfaces are for coupling to a network, such as a cellular network, a wired or wireless local area network, a wired or wireless wide area network, or any other network having at least two interconnected electronic devices.

In an exemplary embodiment, the tactile presentation program 240 “predetermines” properties of resources referenced by links presented (e.g., on display 280) to a user on a page (not shown in FIG. 2) of the web browser 230. For instance, when a new page is presented to a user (e.g., by loading the page in the web browser 230), the tactile presentation program 240 parses the page for links that reference resources. For any link determined to reference a resource, a link portion 207 is created to distinguish this links from any other links. Properties, if any, are determined (e.g., using an HTTP HEAD method) for the resource corresponding to the links in link portion 207 and are stored in properties portion 208. Consequently, when a user sets focus on one of the links corresponding to a link portion 207 in entries 206, the tactile presentation program 240 accesses the property table 205 and determines the properties in property portion 208 corresponding to the link.

In the context of FIG. 1, the electronic device 200 is the internet tablet 110; the tactile feedback device 270 is shown as tactile feedback device 145; the input devices 260 are the stylus 140 in conjunction with the touch screen 112 and the button 121; and the display 280 is the touch screen 112. Other potential input devices 260 include voice controls and “movement controls”, i.e., elements that are based on acceleration/position sensors.

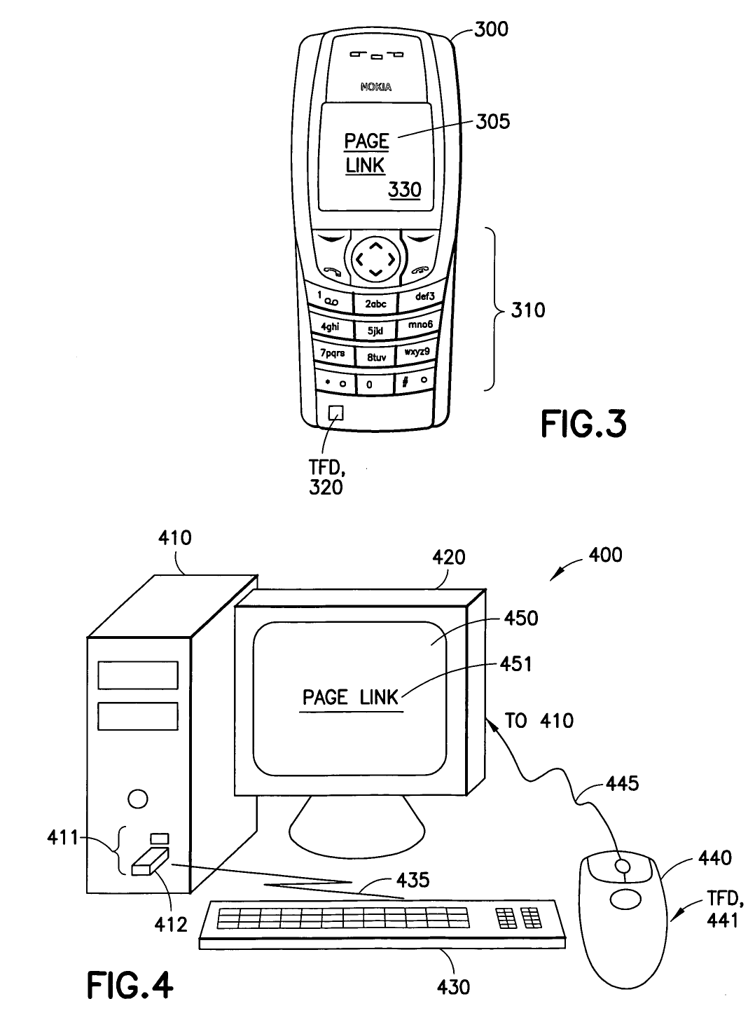

Turning now to FIG. 3 with reference to previous figures, another example is shown of an electronic device 200. The electronic device 200 in FIG. 3 is a cellular phone 300 with internet access capability. The display 330 has a link 305 to a web page. The keypad 310 is used by a user as an input device to set focus on the link 304 and to select the link 305. A tactile presentation program 240 (shown in FIG. 2) causes the tactile feedback device 320 present tactile feedback to the user based on properties of the web page (e.g., web page 165) referenced by the link 305. The processor 255, memory 210, and other internal elements of the cellular phone 300 are not shown in FIG. 3.

Referring now to FIG. 4 with reference to previous figures, another example is shown of an electronic device 200. The computer system 400 shown in FIG. 4 comprises a tower 410 having a processor 255 (see FIG. 2) and memory 210 (see FIG. 2), a liquid crystal display (LCD) monitor 420, a wireless keyboard 430, and a wired force-feedback mouse 440. The tower 410 includes two universal serial bus (USB) ports 411, one of which contains a Bluetooth receiver 412. The wireless keyboard 430 communicates to the Bluetooth receiver 412 using Bluetooth over the wireless channel 435. The force-feedback mouse 440 is coupled to the tower 410 through the wire 445. A browser window 450 is shown including a link 451 to a web page (e.g., web page 165). A tactile presentation program 240 (see FIG. 2) determines when a user has used, e.g., the force-feedback mouse 440 to set focus on the link 451, determines properties of the page referred to by the link 451, and presents tactile information to the user using a tactile feedback device 441 in the force-feedback mouse 440.

Turning to FIG. 5 along with appropriate reference to preceding figures, a graph is shown of a number of different (e.g., distinct) tactile feedback patterns 500. Each tactile feedback pattern 500 is given a name 510 corresponding to a property. In the example of FIG. 5, the properties 520 of the resource can be as follows: “not found”, e.g., a page is not found at the Internet location referenced by the link); “small size”, indicating that the file size of the resource is within a predetermined (e.g., potentially user selectable) range of sizes deemed to be “small”; “large size”, indicating that the file size of the resource is within a predetermined range of sizes deemed to be “large”; “up to date”, indicating that the resource has been updated within a predetermined (e.g., user selectable) time period; and “not up to date”, indicating that the resource has not been updated within a predetermined (e.g., user selectable) time period. Properties 520 of the resource can be checked by using the HTTP HEAD method, which provides metadata information of a page (e.g., its availability, size, or last-modified date for the resource).

It is also noted that a page referenced by a link can include additional embedded links. The information about what is behind each embedded link can be obtained in a similar manner as described in U.S. Pat. No. 6,405,192, i.e., the original page referenced by the link having focus is parsed for embedded links, and each embedded link is checked for, e.g., size. The size corresponding to the original page is then the size of the original page and the sizes of the pages referenced by the embedded links. Furthermore, each embedded link can be checked for whether the resource referenced by the embedded links can be found and a determination as to whether the original link is to be presented to the user with tactile feedback of “not found” if a number of embedded links whose resources cannot be found is determined to be above a threshold.

Also shown are properties 530 of the computer “behind the link”. In other words, in FIG. 1, it could be possible to determine how fast the page host 160 and RSS host 170 are in terms of the ability to serve the page 165 or RSS feed 175, respectively, to determine the congestion of the host 160, 170, or to determine some other speed metric such as link speed between the internet tablet 110 and the computer “behind the link”. Again, the HTTP HEAD method can provide an indication of, e.g., link speed for the resource. The properties 530 are typically used in addition to the properties 520, as additional information as described below.

Each property 520, 530 is assigned a tactile feedback pattern 500. For instance, the “not found” property is assigned the tactile feedback pattern 501. In this example, the amplitude A is used to indicate that the tactile feedback device is “on”. For instance, a vibra motor or piezoelectric actuator may have simple inputs of “on” or “off”. When “on”, the tactile feedback device will vibrate at an amplitude of A and at a frequency of f₁. In the examples of the tactile feedback patterns 502, 503, 504, and 505, each of these has certain “on” and “off” states that comprise patterns. In FIG. 5, each tactile feedback pattern 500 is placed over a duration of two seconds, but two seconds is merely exemplary and other time durations may be used.

In the examples of tactile feedback patterns 506 and 507, these tactile feedback patterns have constant amplitude A, but the tactile feedback device allows a frequency to be set. The frequency for the tactile feedback pattern 506 is a high frequency f₂, and the frequency for the tactile feedback pattern 507 is a low frequency f₃. Some tactile feedback devices also allow variable frequency or variable amplitude. If so, the frequency could be varied from, e.g., low to high frequency to indicate one of the tactile feedback patterns 500. The amplitude could be varied from, e.g., high amplitude to low amplitude to indicate one of the tactile feedback patterns 500. The tactile feedback patterns 500 shown in FIG. 5 are merely representative.

Turning to FIG. 6 along with reference to previous figures, a block diagram is shown of data 600 corresponding to a “not found” tactile feedback pattern 501 in FIG. 5. The data 600 would be stored (e.g., as data 250) in memory 210 of FIG. 2. The tactile presentation program 240 uses the data 600 to at least partially define the tactile feedback pattern 501 shown in FIG. 5. Data 600 includes a frequency 605, pulse 1 information 610, pulse 2 information 615, a repeat indication 620, a repeat amount indication 625, an amplitude indication 630, frequency modulation information 640, and amplitude modulation information 650. In this example, the tactile feedback device allows a frequency to be set and the frequency 605 is f₁. The pulse 1 information 610 includes a duration, start time, and end time to define a single (i.e., the first pulse at zero time) pulse of the tactile feedback pattern 501 of FIG. 5. There is no information about pulse 2, so the tactile presentation program 240 can determine that only one pulse is defined. This pulse is presented once then repeated (as indicated by-repeat indication 620 of “Yes”) ten times (as indicated by repeat amount indication 625 of “10”). Many pulses could be defined. In this example, the tactile feedback device allows an amplitude to be set and the amplitude is A as indicated by amplitude indication 630. There is no frequency modulation (as indicated by frequency modulation information 640 of “None”) and no amplitude modulation (as indicated by amplitude modulation information 650 of “None”).

It should be noted that if a tactile feedback device 270 does not support adjustable frequencies or amplitudes, then one or more of elements 605, 630, 640, and 650 would not be used. If the tactile feedback device 270 does support adjustable frequencies, the frequency modulation information 640 could determine frequency modulation for one or more pulses and typically frequency 605 will not be used. For instance, the frequency modulation information 640 could indicate that pulse 1 is to start at frequency f₁ and linearly increase until an end at frequency f₂ and pulse 2 is to start at frequency f₂ and linearly decrease until an end at frequency f₁. If the tactile feedback device 270 supports adjustable amplitudes, the amplitude modulation information 650 could determine frequency modulation for one or more pulses and typically amplitude 630 will not be used. For instance, the amplitude modulation information 650 could indicate that pulse 1 is to start at amplitude A₁ and linearly increase to end at amplitude A₂ and pulse 2 is to start at amplitude A₂ and linearly decrease to end at A₁.

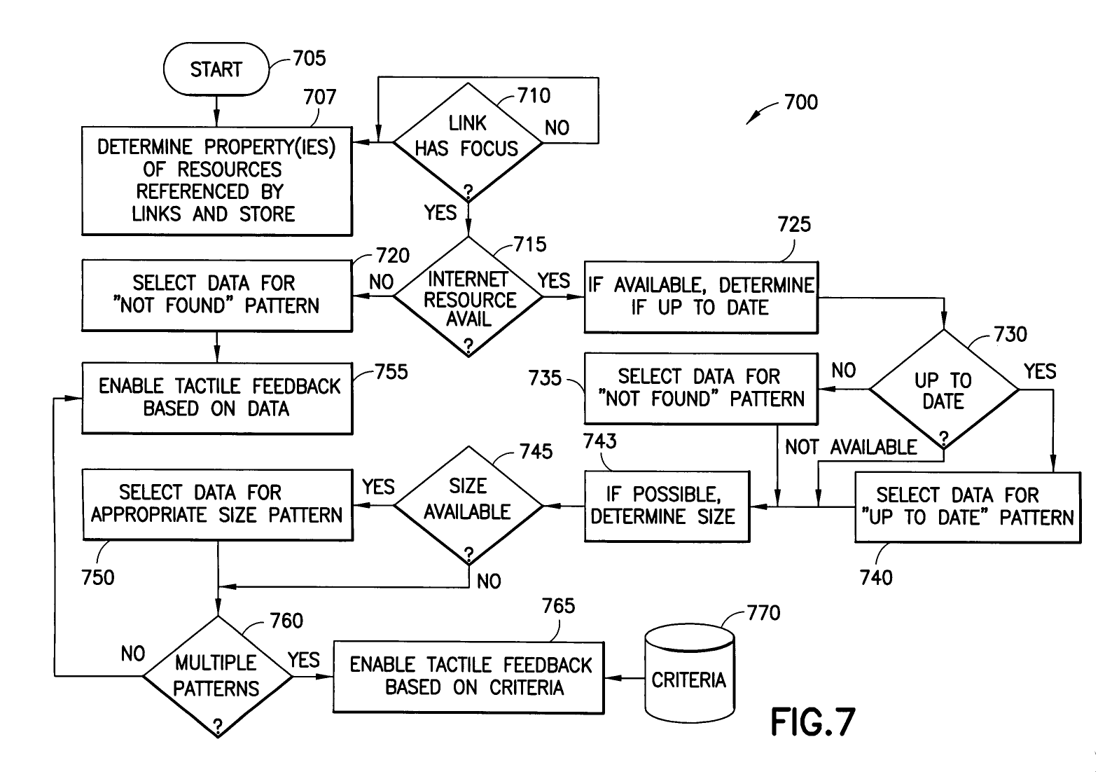

Turning to FIG. 7 with appropriate reference to other figures, a flowchart is shown of a method 700 for tactile presentation of properties of resources referenced through links. Method 700 would typically be performed by the tactile presentation program 240, e.g., when the tactile presentation program 240 is part of the electronic devices 110, 300, or 400.

Method 700 begins in step 705, which is where a new web page is loaded on a web browser 230 and presented to a user. In step 707, the tactile presentation program 240 parses the new web page, determines links that reference resources, and determines properties, if any, for each of the resources referenced by the link. Information that identifies the link and corresponding properties of the resource are stored in step 707. For instance, information that identifies the like could be stored in link portion 207 of the entries 206 in property table 205 (see FIG. 2), and properties for corresponding resources may be stored in property portion 208 of the entries 206 in property table 205. What step 707 does is “predetermine” the properties of resources such that when a user places focus on a link, the tactile presentation program can quickly provide feedback. If step 707 is not used, there will typically be a noticeable delay between when a user places focus on a link and when tactile feedback begins. When step 707 is used, the steps in method 700 that determine properties of resources will access the properties (if any) for a resource by accessing stored information, e.g., in property table 205, of the properties. When step 707 is not used, the steps in method 700 that determine properties of resources will determine the properties using appropriate techniques such as the HTTP HEAD method.

Step 710 waits until a link has a focus. If no focus has been set by a user on a link (step 710=No), the method 700 continues to wait in step 710. When focus is set on a link (step 710=Yes), it is determined if the resource is available in step 715. Such availability can be determined using the HTTP HEAD method. The availability may also be determined using other techniques, such as Ping or sending an HTTP request and waiting for a response. If the resource is not available (step 715=No), then the data for the “not found” tactile feedback pattern (e.g., tactile feedback pattern 501 of FIG. 5) is selected in step 720 and tactile feedback is enabled based on the data in step 755. On the other hand, if the resource is available (step 715=Yes), it is determined if the resource is up to date (step 725). In one exemplary embodiment, a last-modified date is determined for the resource. If the last-modified date is within a predetermined time period such as a week, the resource is considered to be “up to date”; otherwise, the resource is considered to be “not up to date”. The predetermined time period could be user configurable. In another exemplary embodiment, the user selects one or more resources to track. The time when the user last accessed the resource is recorded for each of the tracked resources. When the user sets focus on a link corresponding to one of the tracked resources, step 730 determines whether the resource has been updated after the recorded time. If so, the resource is considered “up to date”; if not, the resource is considered “not up to date”.

If the resource is up to date (step 730=Yes), as determined using for instance the HTTP HEAD method, in revision date (e.g., a revision date is within a predetermined time from time at which step 725 is performed), then data is selected for the “up to date” tactile feedback pattern (e.g., tactile feedback pattern 504 of FIG. 5) in step 740. If the resource is not up to date (step 730=No) in revision date, then data is selected for the “not up to date” tactile feedback pattern (e.g., tactile feedback pattern 505 of FIG. 5) in step 735. If the revision date is not available (e.g., cannot be determined for some reason), then method 700 proceeds from step 730 to step 743. Steps 735 and 740 also end in step 743.

In one exemplary embodiment, in step 743 the size of the resource is determined or is attempted to be determined using the HTTP HEAD method. In another exemplary embodiment, in step 743, the size of the resource (the “original resource”) is determined or is attempted to be determined using the HTTP HEAD method and sizes are determined for the resources referenced by links embedded in the original resource. The information about what is behind each embedded link can be obtained in a similar manner as described in U.S. Pat. No. 6,405,192, i.e., the original resource is parsed for embedded links, and each embedded link is checked for size (e.g., using the HTTP HEAD method). The size of the original resource and the accumulated sizes of the resources referenced by the embedded links are added and also added to the size of the original resource.

If the size is not available or cannot be determined (step 745=No), the method continues in step 760. If it is determined that the size is available and can be determined (step 745=Yes), data is selected that corresponds to an appropriate size of the resource referenced by the focused link. For instance, for an embodiment where only the size of the resource referenced by the focused link is chosen, a size between zero kilobits (kb) and X kb could be chosen as a “small” size. Thus, data corresponding to the tactile feedback pattern 502 would be selected (step 750). For an embodiment where only the size of the resource referenced by the focused link is chosen, a size greater than X kb could be chosen as a “large” size. Thus, data corresponding to the tactile feedback pattern 503 would be selected (step 750). In one exemplary embodiment, default values are used to determine “small” and “large” sizes. For example, 10 kb (kilobytes) could be considered the dividing point between a “small” size (e.g., 10 kb or less) and a “large” size (e.g., greater than 10 kb). In another exemplary embodiment, the user determines these limits and applies them to all resources. For instance, the user could choose to pay for a large amount of bandwidth and decide that the dividing point between “small” and “large” sizes would be, e.g., 100 kb or even 500 kb.

As another example, for an embodiment where the size of the original resource and the size of each resource referenced by embedded links is chosen, a size between zero kilobits (kb) and Y kb, such as 50 kb given X being 10 kb, could be chosen as a “small” size. Again, this setting could be user configurable. Thus, data corresponding to the tactile feedback pattern 502 would be selected (step 750). For an embodiment where only the size of the resource referenced by the focused link is chosen, a size greater than Y kb could be chosen as a “large” size. Thus, data corresponding to the tactile feedback pattern 503 would be selected (step 750).

In step 760, it is determined if there are multiple tactile feedback patterns 500 that are selected (i.e., by selecting data corresponding to such tactile feedback patterns). If there is a single tactile feedback pattern 500 (step 760=No), then tactile feedback is enabled in step 755 for the single tactile feedback pattern 500. Step 720 also continues to step 755. Although not shown, the method 700 would typically continue again at step 710. If there are multiple tactile feedback patterns 500 that are selected (step 760=Yes), then step 765 is performed.

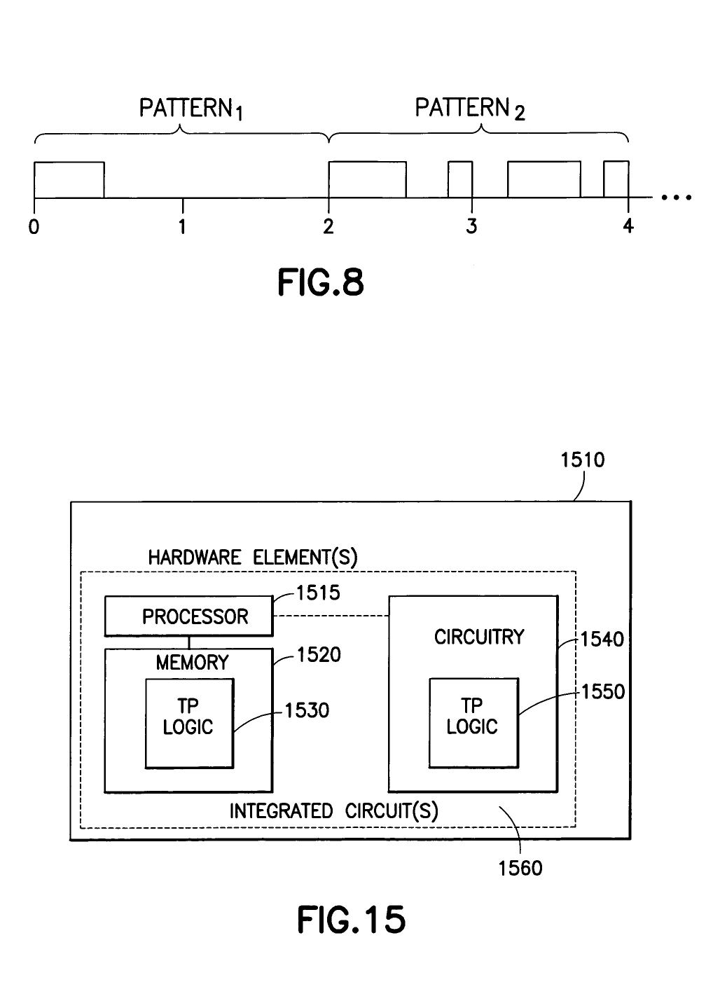

In step 765, if multiple tactile feedback patterns have been selected through corresponding selection of data, in an exemplary embodiment, the multiple tactile feedback patterns are concatenated (e.g., as determined by accessing criteria 770 of “concatenate multiple patterns”). This is shown in FIG. 8. Turning to FIG. 8 in addition to FIG. 7 and other previous figures as necessary, two tactile feedback patterns Pattern₁ and Pattern₂ are shown being concatenated (e.g., one tactile feedback pattern is presented to a user, then a second tactile feedback pattern is presented to a user immediately or shortly after the first is presented). In this example, Pattern₁ is the “small size” tactile feedback pattern 502 and Pattern₂ is the “up to date” tactile feedback pattern 504. Thus, Pattern₁ is reserved for either the “not found” tactile feedback pattern 501 or one of the size tactile feedback patterns 502 and 503. Pattern₂ is reserved for one of the “up to date” or “not up to date” tactile feedback patterns 504, 505 (respectively). Consequently, if there is no size information but the resource is “up to date”, Pattern₁ would be blank (i.e., no tactile feedback during the time period devoted to Pattern₁) but Pattern₂ would be the tactile feedback pattern 504.

In another embodiment, Pattern₁ is reserved for either the “not found” tactile feedback pattern 501 or one of the tactile feedback patterns 502-505 based on the following priority: one of the “size” tactile feedback patterns 502, 503; if size information is not available, then either the “up to date” tactile feedback pattern 504 or the “not up to date” tactile feedback pattern 505. Pattern₂ is not used in this embodiment. In this embodiment, the criteria 770 could contain “do not concatenate patterns”.

In another example, the user is given the option of tactile feedback presentation for Pattern₁ and/or Pattern₂. Therefore, the user could select (e.g., where such selection is stored as criteria 770) that only one tactile feedback pattern 501-505 would be presented based on priority, which would be selected by the user. As another example, the user might desire both Pattern₁ and Pattern₂ to be presented, but could select that “up to date” tactile feedback pattern 504 or the “not up to date” tactile feedback pattern 505 be presented in Pattern₁. This could be helpful if the user desires to know when a website having a score or other news for a particular sporting event is updated. Still other options are available. User preferences would be stored as criteria 770.

It should be noted that method 700 as written might also not enable any tactile feedback. For example, if step 715=Yes, step 730=Not Available, and step 745=No, then no tactile feedback will be enabled as no data corresponding to a tactile feedback pattern will have been selected. In this example, no tactile feedback is equivalent to “found, but no other information is available about the resource referenced by the focused link”. If desired, a tactile feedback pattern could be assigned to “found, but no other information is available about the resource referenced by the focused link”.

It is also noted that the tactile presentation program 240 will enable the tactile feedback in steps 755 and 765 by providing information from the data 600 to the tactile feedback device 270 (e.g., tactile feedback device 145, 320, and 441 of FIGS. 1, 3, and 4, respectively) to cause the tactile feedback device 270 to provide a tactile feedback pattern 500. Illustratively, for a tactile feedback device 270 that accepts “on” and “off” control signals (e.g., hardwired or software or a combination thereof), the tactile presentation program 240 will provide, as defined by the data 600, the “on” and “off” control signals to the tactile feedback device 270 at appropriate times to cause a selected tactile feedback pattern 500 at the tactile feedback device 270. For a tactile feedback device 270 that also accepts frequency 605, amplitude 630, frequency modulation information 640, or amplitude modulation information 650, the tactile presentation program 240 will also provide the respective information at appropriate times to the tactile feedback device 270 in order to cause the selected tactile feedback pattern 500 at the tactile feedback device 270.

It is additionally noted that FIG. 7 does not address the “high speed” tactile feedback pattern 506 or “low speed” tactile feedback pattern 507. However, these tactile feedback patterns could be added, e.g., by presenting a third tactile feedback pattern after Pattern₂ in FIG. 8. As another embodiment, the Pattern₁ in FIG. 8 would be reserved for one of the tactile feedback patterns 501-505 and Pattern₂ in FIG. 8 would be reserved for one of the tactile feedback patterns 506 or 507. As yet another example, each of the “small file” tactile feedback pattern 502 and “large file” tactile feedback pattern 503 are modified by one of the frequencies f₂ or f₃ in the “high speed” tactile feedback pattern 506 or “low speed” tactile feedback pattern 507, respectively. As an example, if the size of the resource is “small” but the speed of the computer hosting the resource is “high”, the “small size” tactile feedback pattern 502 could be used but tactile feedback is presented at the relatively high frequency of f₂. As another example, if the size of the resource is “small” but the speed of the computer hosting the resource is “low”, the “small size” tactile feedback pattern 502 could be used but tactile feedback is presented at the relatively low frequency of f₃.

It is also noted that internet tablet 110, the cellular phone 300, and the computer system 400 could allow the user to define additional types of properties other than those shown as properties 520. For instance, one such property could be whether a web page (e.g., page 165 of FIG. 1) is in Finnish. The user could also assign a tactile feedback pattern 500 to the property. This user-defined property would then be used in method 700 in order to determine whether a resource has that property and produce a tactile feedback pattern 500 in response to the user-defined property.

Referring to FIG. 9 with appropriate reference to other figures, a diagram 902 is shown of events 905-950 for a gesture when user interacts with a touch screen and of software interactions in response to the events 905-950. The events 905-950 are similar to the structure of a touch screen gesture as shown in Popyrev and Maruyama, “Tactile interfaces for touch screens”, ACM, UIST 2003. The diagram 902 represents a gesture made a user using a finger, stylus (e.g., stylus 140 of FIG. 1), or other touch screen input device.

A gesture starts (event 905) when a user touches down (event 910) on the touch screen. One gesture includes a touch down (event 910) followed by a drag to a link (event 930) presented on the touch screen, followed by a drag past the link (event 935), followed by lift off (event 940). For this gesture, the tactile presentation program 240 typically will not respond. In one embodiment, if the user delays (path 931) on the link for a predetermined time period (e.g., 100 milliseconds), the gesture will be considered to follow the path 931 from the drag to link event 930 to the hold on link event 920; In another embodiment, all drags to the link (event 930) could result, regardless in delay, of following path 931 and path 932 would not exist.

Another gesture includes a touch down (event 910) directly onto the link and a hold on the link (event 920). When the event 920 is reached, a message 961 is communicated to the web browser 955 (e.g., the web browser 230 in FIG. 2). The message 961 is typically communicated by an operating system (e.g., operating system 220 in FIG. 2). As is known in the art, the message 961 may be a message placed in a queue for the web browser 955. In response to message 961, the web browser 955 would set focus on the link (step 960). The web browser 955 then would communicate message 963 to the tactile presentation program 965 (e.g., tactile presentation program 240 of FIG. 2). The message 963 could be, e.g., a message placed into an input queue of the tactile presentation program 965, a statement causing the tactile presentation program 965 to be executed, or other hardwired or software messages.

In response to message 963, the tactile presentation program 965 performs steps 970 and 980, which represent simplified versions of method 700. In response to the focus being set on the link, the tactile presentation program 965 determines a property (or properties) of the resource referenced by the link and determines data for the tactile feedback patterns that correspond to the properties (step 970). The tactile presentation program 965 also enables tactile feedback using the data (step 980).

During an interaction with the user where the user wants to be presented with tactile feedback based on the properties of a resource referenced by a link, the user will perform a gesture to end up at the hold on link event 902. The user will hold position (e.g., of a finger or stylus) until the tactile feedback is presented (step 980 of FIG. 9) and then will either follow path 921 to the drag past link event 935 and then to the lift off event 940 (i.e., thereby canceling selection of the link) or follow path 922 to the lift off link event 950. Lift off link event 950 causes a message 962 to be sent (e.g., by an operating system 220) to the web browser 955. In response to message 962, the web browser 955 selects the link (step 990). As described above, selecting the link causes the link to be followed to the referenced resource.

Also in response to the message 962, the web browser 955 could send the message 964 to the tactile presentation program 965. Message 964 allows the tactile presentation program 965 to stop the steps 970 and 980, should the user desire to terminate either step prior to the normal end of tactile feedback.

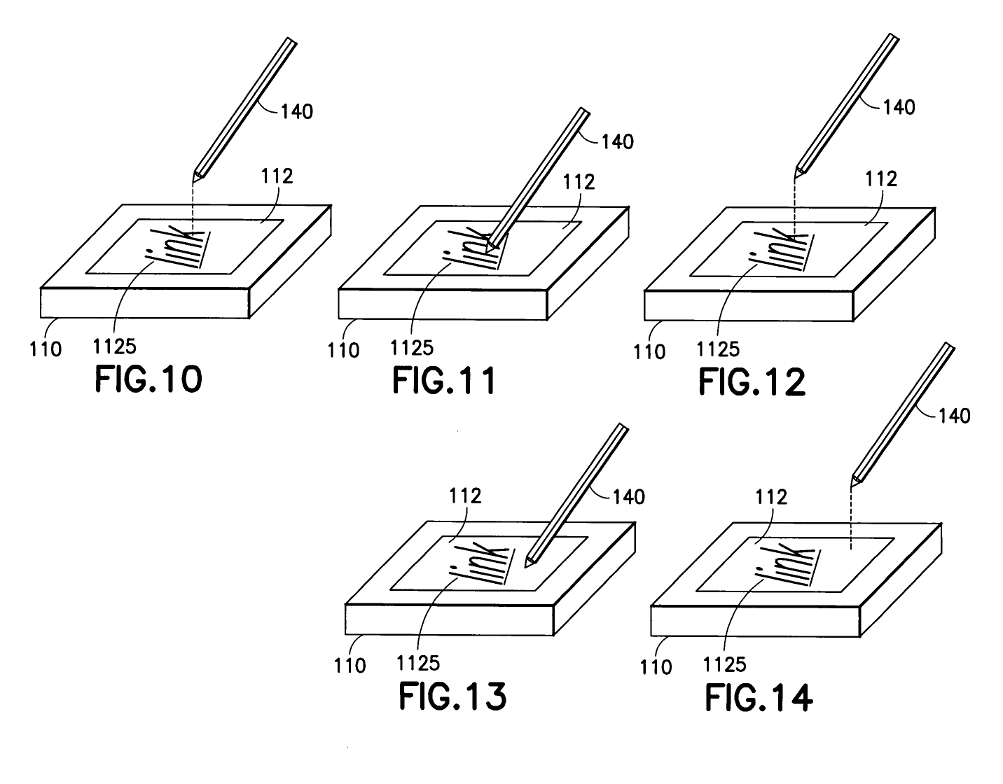

FIGS. 10-14 are examples of events of FIG. 9 for gestures using a touch screen. FIG. 10 shows an internet tablet 110 with a touch screen 112 and a stylus 140 that is placed in the start event 905 of FIG. 9. FIG. 11 represents the touch down event 910, when the user places the stylus 140 on the touch screen 112 and on the link 1125. FIGS. 12 and 13 represent different possible paths taken by the stylus 140. In FIG. 12, the hold on event 920 and the lift off link event 950 are performed. In FIG. 13, the hold on link event 920 and drag past link event 939 are performed. FIG. 14 illustrates a path taken after FIG. 13, where the user performs the lift off event 940.

The embodiments of this invention may be implemented by computer software executable by a processor 255, or by hardware circuitry, or by a combination of computer software and hardware circuitry. For instance, FIG. 15 shows a block diagram of possible hardware element(s) 1510 used to implement tactile presentation logic. In this example, the hardware element(s) 1510 include a processor 1515 and memory 1520 and circuitry 1540. The memory 1520 includes tactile presentation (TP) logic 1530 and the circuitry 1540 includes TP logic 1550. The processor 1515, memory 1530, and circuitry 1540 could be implemented as one or more integrated circuits 1560. The circuitry 1540 could be implemented as element(s) separate from or integrated onto the integrated circuit(s) 1560. TP logic may be integrated on both memory 1530 and circuitry 1540 or could be implemented on only one of the memory 1530 or the circuitry 1540.

Further in this regard it should be noted that the various blocks of the logic flowchart of FIG. 7 might represent program steps, or interconnected logic circuits, blocks and functions, or a combination of program steps and logic circuits, blocks and functions for performing the specified tasks.

In general, the various embodiments of suitable electronic devices include any device able to connect to a resource. Such electronic devices include, but are not limited to, cellular telephones, personal digital assistants (PDAs), portable computers, gaming devices, music storage and playback appliances, Internet appliances permitting wired or wireless Internet access and browsing, as well as portable units or terminals that incorporate combinations of such functions.

The memory (e.g., 210) may be of any type suitable to the local technical environment and may-be implemented using any suitable data storage technology, such as semiconductor-based memory devices, magnetic memory devices and systems, optical memory devices and systems, fixed memory and removable memory. The processor (e.g., 255) may be of any type suitable to the local technical environment, and may include one or more of general purpose computers, special purpose computers, microprocessors, digital signal processors (DSPs) and processors based on a multi-core processor architecture, as non-limiting examples.

Embodiments of the invention may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the best techniques presently contemplated by the inventors for carrying out embodiments of the invention. However, various modifications and adaptations may become apparent to those skilled in the relevant arts in view of the foregoing description, when read in conjunction with the accompanying drawings and the appended claims. For instance, although “web pages” have been described herein, the disclosed invention can be used on any network and the term “resource” includes resources such as pages on a local network. All such and similar modifications of the teachings of this invention will still fall within the scope of this invention.

Furthermore, some of the features of exemplary embodiments of this invention could be used to advantage without the corresponding use of other features. As such, the foregoing description should be considered as merely illustrative of the principles of embodiments of the present invention, and not in limitation thereof.

What is claimed is:

1. A method comprising:
in response to focus being set on a link referencing a resource, determining at least one property of the resource referenced by the link;
selecting data corresponding to at least one of a plurality of tactile feedback patterns based on the at least one property; and
enabling tactile feedback corresponding to the at least one tactile feedback pattern based at least in part on the data.

2. The method of claim 1, wherein enabling further comprises causing a tactile feedback device to produce the tactile feedback.

3. The method of claim 1, wherein:
determining at least one property of the resource referenced by the link further comprises determining a plurality of properties of the resource referenced by the link; and
selecting data further comprises selecting data corresponding to a selected plurality of tactile feedback patterns wherein one of the selected plurality of tactile feedback patterns corresponds to one of the plurality of properties.

4. The method of claim 3, wherein enabling tactile feedback further comprises enabling tactile feedback corresponding to each of the selected plurality of tactile feedback patterns, wherein each tactile feedback pattern is presented at one of a plurality of time periods.

5. The method of claim 1, wherein enabling tactile feedback further comprises enabling based on criteria tactile feedback corresponding to only one of the plurality of tactile feedback patterns.

6. The method of claim 1, wherein the at least one property comprises at least one of the following: whether the resource referenced by the link is found; a size of the resource referenced by the link; and whether the reference referenced by the link is up to date or is not up to date.

7. The method of claim 1, wherein the at least one property comprises a size of the resource referenced by the link.

8. The method of claim 1, wherein:
the at least one property comprises a size associated with the resource referenced by the link;
the plurality of tactile feedback patterns comprise a first tactile feedback pattern corresponding to a first size and a second tactile feedback pattern corresponding to a second size; and
selecting data further comprises selecting data corresponding to the first tactile feedback pattern when the size is within a first predetermined range and selecting data corresponding to the second tactile feedback pattern when the size is within a second predetermined range.

9. The method of claim 1, wherein the resource is a first resource, wherein the at least one property comprises a result of a size of the first resource added to a size of second resources referenced by links embedded in the first resource.

10. The method of claim 1, wherein:
the at least one property comprises whether the resource referenced by the link is up to date or not up to date;
the plurality of tactile feedback patterns comprise a first tactile feedback pattern corresponding to the resource referenced by the link being up to date and a second tactile feedback pattern corresponding to the resource referenced by the link not being up to date; and
selecting data further comprises selecting data corresponding to the first tactile feedback pattern in response to the resource being up to date and further comprises selecting data corresponding to the second tactile feedback pattern in response to the resource being not up to date.

11. The method of claim 1, wherein:
selecting data further comprises selecting additional data corresponding to another one of the plurality of tactile feedback patterns based on a speed of a host of the resource; and
enabling further comprises enabling tactile feedback corresponding to the other tactile feedback pattern based at least in part on the additional data.

12. The method of claim 1, wherein the link is a hyperlink.

13. The method of claim 1, wherein:
the method further comprises:
parsing a page to determine each of the links in the page that reference resources;
determining properties, if any, of the resources referenced by the links; and
storing the properties of the resources referenced by the links; and
determining at least one property of the resource referenced by the link further comprises accessing the stored properties to determine the at least one property of the resource.

14. The method of claim 13, wherein parsing a page is performed in response to the page comprising the link being at least partially presented to a user.

15. The method of claim 1, further comprising accessing at least one network in order to determine the at least one property of the resource referenced by the link.

16. An electronic device comprising:
at least one memory comprising a set of instructions; and
at least one processor coupled to the at least one memory and executing the set of instructions, the at least one processor configured by the set of instructions to determine, in response to focus being set on a link referencing a resource, at least one property of the resource referenced by the link, to select data corresponding to at least one of a plurality of tactile feedback patterns based on the at least one property, and to enable tactile feedback corresponding to the at least one tactile feedback pattern based at least in part on the data.

17. The electronic device of claim 16, further comprising a tactile feedback device coupled to the processor, and wherein enabling the tactile feedback causes the tactile feedback device to produce the tactile feedback.

18. The electronic device of claim 17, wherein the tactile feedback device comprises a mouse and wherein the tactile feedback comprises force-feedback caused by the mouse.

19. The electronic device of claim 17, wherein the tactile feedback device comprises a touch screen and wherein the tactile feedback comprises force-feedback caused by the touch screen.

20. The electronic device of claim 17, further comprising a body, wherein the tactile feedback device is coupled to the body of an electronic device, and wherein the tactile feedback comprises vibration by the tactile feedback-device.

21. The electronic device of claim 20, wherein the tactile feedback device comprises at least one of a vibra motor or a piezoelectric actuator.

22. The electronic device of claim 16, further comprising a display configured to display the link and at least one input device configured to allow a user to cause the focus to be set on the link.

23. The electronic device of claim 16, wherein the link is a hyperlink.

24. The electronic device of claim 16, wherein the at least one processor is further configured by the set of instructions to parse a page to determine each of the links in the page that reference resources, to determine properties, if any, of the resources referenced by the links, to store the properties of the resources referenced by the links, and, when determining at least one property of the resource referenced by the link, to access the stored properties to determine the at least one property of the resource.

25. The electronic device of claim 24, wherein the at least one processor is further configured by the set of instructions to parse the page in response to the page comprising the link being at least partially presented to a user.

26. The electronic device of claim 16, further comprising at least one network interface, and wherein the at least one processor is further configured by the set of instructions to access a network coupled to the at least one network interface in order to determine the at least one property of the resource referenced by the link.

27. A signal bearing medium tangibly embodying a program of machine-readable instructions executable by a processor to perform operations comprising:
in response to focus being set on a link referencing a resource, determining at least one property of the resource referenced by the link;
selecting data corresponding to at least one of a plurality of tactile feedback patterns based on the at least one property; and
enabling tactile feedback corresponding to the at least one tactile feedback pattern based at least in part on the data.

28. A system comprising:
a network;
a first electronic device coupled to the network and comprising a resource;
a second electronic device coupled to the network, the second electronic device comprising:
a network interface;
at least one memory comprising a set of instructions; and
at least one processor coupled to the at least one memory and executing the set of instructions, the at least one processor configured by the set of instructions to determine, in response to focus being set on a link referencing the resource, at least one property of the resource referenced by the link, the determination made by using the network interface to access the first electronic device through the network, the at least one processor further configured by the set of instructions to select data corresponding to at least one of a plurality of tactile feedback patterns based on the at least one property, and to enable tactile feedback corresponding to the at least one tactile feedback pattern based at least in part on the data.
